(19) United States
(12) Patent Application Publication
(10) Pub. No.: US 2008/0165166 A1
(43) Pub. Date: Jul. 10, 2008

(54) APPARATUS FOR DRIVING LASER DIODE USED IN IMAGE DISPLAY

(75) Inventor: Seung-choul SONG, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/856,162

(22) Filed: Sep. 17, 2007

(30) Foreign Application Priority Data
Jan. 8, 2007 (KR) 10-2007-0002175

(51) Int. Cl. G09G 5/00

(52) U.S. Cl. 345/204

(57) ABSTRACT

An apparatus for driving a laser diode (LD) used in an image display. The apparatus includes a signal converter which converts an input image signal into a digital image signal; first through N^{th} (where N is a positive integer greater than or equal to “1”) current output devices which output currents; a current output device selector which selects the first through K^{th} (where K is greater than or equal to “1” and smaller than or equal to N) current output devices among the first through N^{th} current output devices, so as to output a current corresponding to the digital image signal; and an LD unit which emits laser beams corresponding to the currents output from the first through K^{th} current output devices.

### CROSS-REFERENCE TO RELATED PATENT APPLICATION

This application claims priority from Korean Patent Application No. 10-2007-0002175, filed on Jan. 8, 2007 in the Korean Intellectual Property Office, the disclosure of which is incorporated herein in its entirety by reference.

### BACKGROUND OF THE INVENTION

1. Field of the Invention

The present invention relates to a display system using a laser diode (LD), and more particularly, to an apparatus for driving an LD used in an image display, which can be used in a current driving circuit for driving a high current.

2. Description of the Related Art

A related art display device having an LD includes an automatic power controller, an LD array, a mirror, a motor, etc. The automatic power controller stably oscillates a laser if image data is input. The LD array includes a plurality of LDs projecting laser beams under the control of the controller. The mirror reflects the laser beams output from the LD array onto a screen. The motor rotates the mirror.

The related art display device supplies a current so that the LD array projects light corresponding to image data. The current is obtained through a conversion of a voltage corresponding to a signal level of the image into a current. The obtained current is supplied to emit light from the LD array so as to display an image corresponding to the image data.

However, a method of connecting a plurality of transistors to supply the current corresponding to the image data using an analog method is used to supply the current corresponding to the signal level of the image data. If the method is used, the high-speed conversion of the voltage into the current is limited, and the design of a circuit for supplying a high power current is complicated.

### SUMMARY OF THE INVENTION

The present invention provides an apparatus for driving an LD used in an image display, by which an amount of current corresponding to an image signal can be changed using digital current output devices to change the current at a high speed.

According to an aspect of the present invention, there is provided an apparatus for driving an LD used in an image display, including: a signal converter which converts an input image signal into a digital image signal; first through N^{th} (where N is a positive integer greater than or equal to “1”) current output devices which output currents; a current output device selector which selects the first through K^{th} (where K is greater than or equal to “1” and smaller than or equal to N) current output devices among the first through N^{th} current output devices, so as to output a current corresponding to the digital image signal; and an LD unit which emits laser beams corresponding to the currents output from the first through K^{th} current output devices.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of an apparatus for driving an LD used in an image display according to an exemplary embodiment of the present invention;

FIG. 2 is a circuit diagram of current output devices of FIG. 1; and

FIG. 3 is a graph illustrating differences among currents output from current output devices.

### DETAILED DESCRIPTION OF EXEMPLARY EMBODIMENTS OF THE INVENTION

An apparatus for an LD used in an image display according to an exemplary embodiment of the present invention will now be described in detail with reference to the attached drawings.

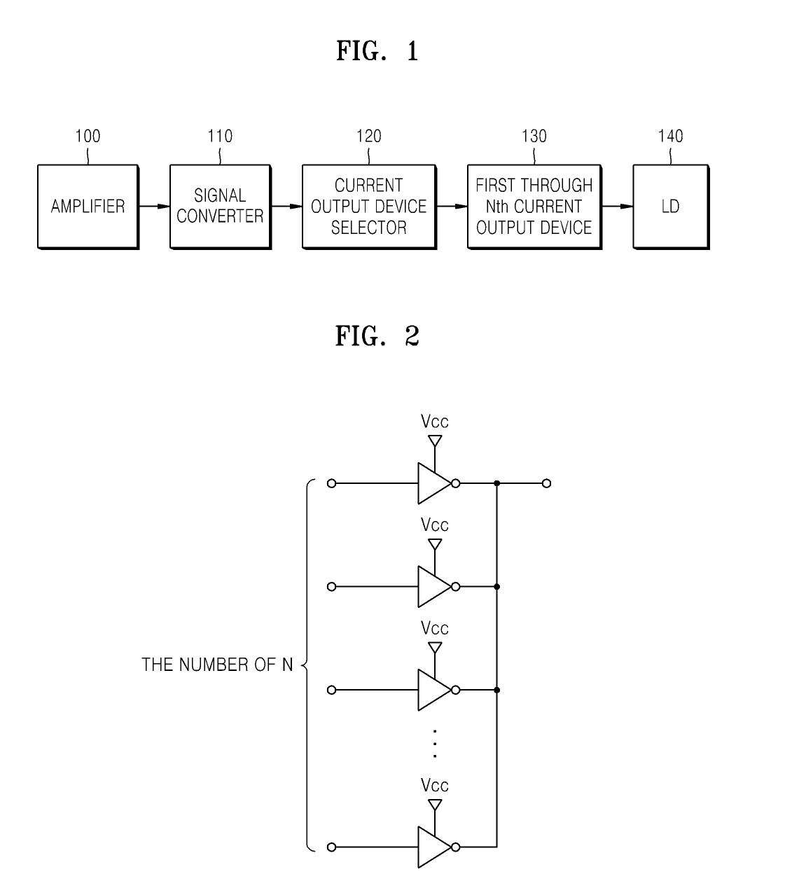

FIG. 1 is a block diagram of an apparatus for driving an LD used in an image display according to an exemplary embodiment of the present invention.

Referring to FIG. 1, the apparatus for driving the LD includes an amplifier 100, a signal converter 110, a current output device selector 120, first through N^{th} (where N is a positive integer greater than or equal to “1”) current output devices 130, and an LD unit 140.

The amplifier 100 amplifies an input image signal and outputs an amplified analog image signal to the signal converter 110. The amplifier 100 amplifies the input image signal using an operational amplifier.

The signal converter 110 converts the amplified analog image signal into a digital image signal and outputs the digital image signal to the current output device selector 120. An analog-to-digital converter (ADC) may perform a function of the signal converter 110.

The current output device selector 120 selects the first through K^{th} (where K is a positive integer greater than or equal to “1” and smaller than or equal to N) current output devices among the first through N^{th} current output devices 130 and outputs a selection result to the first through N^{th} current output devices 130, so that a current corresponding to the digital image signal is output. The current output device selector 120 detects an output current from a voltage corresponding to an output level of the digital image signal, wherein the output current depends on the corresponding voltage. The current output device selector 120 selects a specific number of current output devices among the first through N^{th} current output devices 130 so that a current corresponding to an intensity of the detected output current. For example, if a voltage corresponding to the output level of the digital image signal is “0.1 [v],” and a current corresponding to the voltage is “10 [mA],” the current output device selector 120 selects one current output device outputting the current “10 [mA].” If the voltage is “5 [v],” and the current is “1000 [mA],” the current output device selector 120 selects one hundred current output devices outputting currents “10 [mA].” The current output device selector 120 supplies a predetermined power source to K current output devices so that N current output devices output currents corresponding to an image signal. The K current output devices supplied with the predetermined power source output predetermined currents, respectively.

The first through N^{th} current output devices 130 receive the predetermined power source, output predetermined minute currents, and output the predetermined minute currents to the LD unit 140. The number of current output devices may be arbitrarily determined by a designer according to an intensity of an output current. In other words, a plurality of current output devices may be provided to output a high-power current.

In particular, the first through N^{th} current output devices 130 are inverter devices. If a predetermined voltage is “0,” current output devices selected by the current output device selector 120 are turned off to intercept a current. If a predetermined voltage larger than “0” is supplied, the current output devices are turned on to allow a current to flow. In an exemplary embodiment of the present invention, a 20 [MHz] high-speed operation can be realized using a high-speed digital integrated circuit (IC), and a number of devices can be increased or reduced to turn the devices on and/or off so as to change a current.

FIG. 2 is a circuit diagram of current output devices of FIG. 1.

Referring to FIG. 2, N current output devices are provided and supplied with a predetermined power source, e.g., Vcc=5 [v], to output currents of 10 [mA], respectively. For example, the predetermined power source is supplied to three current output devices of the N current output devices according to a selection signal of the current output device selector 120 to request an output of a current of 30 [mA] corresponding to an image signal, so that the current of 30 [mA] is output. Thus, currents of 10 [mA] are output from the three current output devices, respectively, and the current of 30 [mA] corresponding to a sum of the currents of 10 [mA] is output.

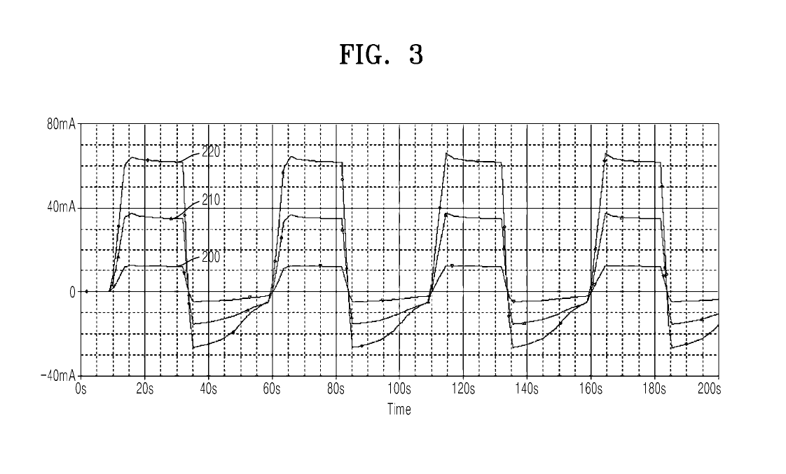

FIG. 3 is a graph illustrating differences among currents output from current output devices.

Referring to FIG. 3, reference numeral 200 denotes variations of a current with time if one current output device is selected. Also, reference numeral 210 denotes variations of a current with time if two current output devices are selected, and reference numeral 220 denotes variations of a current with time if three current output devices are selected. As shown in FIG. 3, a current supplied to the LD unit 140 is changed according to the number of current output devices.

The LD unit 140 emits laser beams corresponding to currents output from the first through K^{th} current output devices. For example, if a current of 30 [mA] is output from three current output devices according to the selection signal of the current output device selector 120 to request the output of the current of 30 [mA] corresponding to the image signal, as described above with reference to FIG. 2, the LD unit 140 emits a laser beam corresponding to the current of 30 [mA]. An image is displayed on a screen through the emission of the LD unit 140. At least one or more LDs may be provided in the LD unit 140. In other words, the LD unit 140 of an exemplary embodiment of the present invention may be an array of a plurality of LDs.

Components of the apparatus for driving the LD used in the image display according to an exemplary embodiment of the present invention are provided so as to correspond to R, G, and B colors, respectively. In other words, the apparatus for driving the LD including the amplifier 100, the signal converter 110, the current output device selector 120, the first through N^{th} current output devices 130, and the LD unit 140 is provided so as to display an image signal corresponding to the R color. Also, the apparatus for driving the LD including the amplifier 100, the signal converter 110, the current output device selector 120, the first through N^{th} current output devices 130, and the LD unit 140 is provided so as to display an image signal corresponding to the G color. Also, the apparatus for driving the LD including the amplifier 100, the signal converter 110, the current output device selector 120, the first through N^{th} current output devices 130, and the LD unit 140 is provided so as to display an image signal corresponding to the B color.

As described above, in an apparatus for driving an LD used in an image display according to an exemplary embodiment of the present invention, an amount of current corresponding to an image signal can be easily changed using current output devices. Thus, the current can be changed at a high speed. Also, a number of current output devices can be increased to change the current through a high power source. As a result, the image signal can be more minutely output as an image.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for driving a laser diode used in an image display, the apparatus comprising:
a signal converter which converts an input image signal into a digital image signal;
first through N^{th}, where N is a positive integer greater than or equal to “1,” current output devices which output currents;
a current output device selector which selects the first through K^{th}, where K is a positive integer greater than or equal to “1” and smaller than or equal to N, current output devices among the first through N^{th} current output devices, so as to output a current corresponding to the digital image signal; and
a laser diode unit which emits laser beams corresponding to the currents output from the first through K^{th} current output devices.

2. The apparatus of claim 1, wherein the first through N^{th} current output devices comprise inverter devices.

3. The apparatus of claim 1, wherein components of the apparatus for driving the laser diode are provided, so as to correspond to R, G, and B colors, respectively.

4. The apparatus of claim 1, further comprising an amplifier which amplifies the input image signal.

5. The apparatus of claim 1, wherein the laser diode unit comprises at least one laser diode.
